(19) United States
(12) Patent Application Publication
(10) Pub. No.: US 2007/0111093 A1
(43) Pub. Date: May 17, 2007

(54) NON-AQUEOUS ELECTROLYTE SECONDARY BATTERY

(75) Inventors: Katsumi Kashiwagi, Osaka (JP); Masato Fujikawa, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/671,232

(22) Filed: Feb. 5, 2007

(30) Foreign Application Priority Data
Feb. 6, 2006 (JP) 2006-028143

(51) Int. Cl. H01M 10/40; H01M 4/58; H01M 4/62

(52) U.S. Cl. 429/199; 429/200; 429/326; 429/330; 429/218.1; 429/232

(57) ABSTRACT

A non-aqueous electrolyte secondary battery of the present invention includes a positive electrode, a negative electrode, a separator, and a non-aqueous electrolyte. The negative electrode includes an active material and carbon nanofibers, and an end of the carbon nanofiber is attached to the active material. The non-aqueous electrolyte includes a non-aqueous solvent and a solute dissolved therein. The non-aqueous solvent includes a first solvent and a second solvent: the first solvent is a fluorine-containing compound and the second solvent is a solvent other than the fluorine-containing compound.

### FIELD OF THE INVENTION

The present invention relates to non-aqueous electrolyte secondary batteries. To be more specific, the present invention relates to improvements in the negative electrode and the non-aqueous electrolyte of non-aqueous electrolyte secondary batteries.

### BACKGROUND OF THE INVENTION

Recently, in the field of non-aqueous electrolyte secondary batteries, researches have been actively conducted on lithium ion secondary batteries which have high voltage and high energy density.

Conventionally, electrodes of non-aqueous electrolyte secondary batteries are formed of a current collector, an active material as a charge and discharge reaction material, a binder for sticking the active material to the current collector, and a thickener. Further, when the active material itself does not have sufficient electron conductivity, the electron conductivity of the electrode is improved by mixing the active material with a highly electron conductive material, such as graphite and amorphous carbon. For example, in positive electrodes of lithium ion secondary batteries, a material with high electron conductivity is added to the positive electrode active material such as lithium cobaltate.

However, when the active material itself has very low electron conductivity, even the active material is mixed with a material with high electron conductivity to allow the contact between the active material and the material with high electron conductivity, sufficient conductivity may not be ensured.

Further, when using an active material which involves significant expansion and shrinkage upon charging and discharging, repetitive charge and discharge render the contact between the active material and the material with high electron conductivity insufficient, which decreases the electron conductivity in the active material gradually. Thus, when charge and discharge cycles are repeated many times, the capacity retention rate declines.

To solve the above problem, for example, there has been proposed to bind carbon fibers at the surface of the active material (Japanese Laid-Open Patent Publication No. 2004-349056). Based on this proposal, the electron conductivity in the active material can be kept high, even though the active material expansion and shrinkage involved with charge and discharge cycles are repeated.

On the other hand, for the purpose of improving battery performance, there has been an attempt to blend in various additives to the positive electrode active material layer, the negative electrode active material layer, and/or the non-aqueous electrolyte. For example, Japanese Laid-Open Patent Publication No. 2003-132950 and Japanese Laid-Open Patent Publication No. 2004-139963 have proposed adding a fluorine-containing aromatic compound to the non-aqueous electrolyte. In technique disclosed in Japanese Laid-Open Patent Publication No. 2003-132950, the fluorine-containing aromatic compound is adsorbed on the negative electrode surface, or is reacted with the negative electrode active material, to form a coating film on the negative electrode active material surface, thereby curbing the side reaction between the non-aqueous electrolyte and the negative electrode active material. This improves charge and discharge cycle performance. Japanese Laid-Open Patent Publication No. 2004-139963 describes that the fluorine-containing aromatic compound curbs gas generation at the time of continuous charging.

Non-aqueous electrolytes used for non-aqueous electrolyte secondary batteries generally include a non-aqueous solvent and a solute dissolved therein. For the non-aqueous solvent, a cyclic carbonic acid ester, a linear carbonic acid ester, and a cyclic carboxylic acid ester are used; and for the solute, lithium hexaflurophosphate (LiPF₆) and lithium tetrafluoroborate (LiBF₄) are used.

Based on the examination by the inventors of the present invention, it was found that when carbon fibers were attached to the active material surface, active material wettability by the non-aqueous electrolyte declined. That is, active material wettability by the electrolyte greatly differs between the cases, i.e., the case when carbon fibers are attached to the active material surface, and the case when carbon fibers are used as the negative electrode active material or a carbon material is merely mixed with the negative electrode active material.

For example, Japanese Laid-Open Patent Publication No. 2003-132950 notes that carbon fibers may be used as the negative electrode active material, and Japanese Laid-Open Patent Publication No. 2004-139963 notes that carbon black may be used as the conductive material for the negative electrode.

When the active material and carbon black are merely mixed, since the active material surface is constantly contacting the non-aqueous electrolyte, even though carbon black that was mixed in as the conductive material was not completely wetted by the non-aqueous electrolyte, as long as the active material surface is making contact with the non-aqueous electrolyte, charge and discharge reaction can take place via the non-aqueous electrolyte. Thus, low carbon black wettability by the non-aqueous electrolyte does not greatly affect battery performance. This is also the case when the active material is merely mixed with carbon fibers.

On the other hand, when carbon fibers are attached to the active material surface, since the active material surface is covered with carbon fibers, the non-aqueous electrolyte does not reach the active material surface unless the carbon fibers are wetted completely. Thus, unless carbon fibers are wetted by the non-aqueous electrolyte completely, charge and discharge reaction does not take place. Therefore, carbon fiber wettability by the non-aqueous electrolyte greatly affects battery performance.

For example, when a low electron conductivity active material was used, and the amount of carbon fibers was increased to improve the conductivity of the electrode for better cycle performance, active material wettability by the non-aqueous electrolyte declines greatly. Thus, bubbles remain at portions not contacting the non-aqueous electrolyte, greatly affecting battery performance. Further, such decline in wettability extends the time it takes to impregnate the electrode with the non-aqueous electrolyte. This declines battery productivity. With less amount of carbon fibers (0.5 to 5 wt %) attached to the active material surface, even though carbon fibers are attached to the active material surface, charge and discharge reactions are not greatly affected, as shown in the technique of Japanese Laid-Open Patent Publication No. 2004-349056.

The present invention was achieved in view of the above problems, and aims to provide a high capacity non-aqueous electrolyte secondary battery with excellent charge and discharge cycle performance and productivity when a low electron conductive active material is used.

### BRIEF SUMMARY OF THE INVENTION

As a result of diligent examination, the inventors of the present invention arrived at the following two findings. Firstly, when carbon nanofibers are attached to the active material, the surface area becomes very large, which declines the non-aqueous electrolyte accessibility to the active material. Secondly, when the electron conductivity of the active material is very low, sufficient electron conductivity cannot be obtained unless a certain amount or more of carbon nanofibers is attached to the active material.

The present invention is based on the above two new findings, and improves permeability of the electrode to the non-aqueous electrolyte by adding a solvent comprising a fluorine-containing compound to the non-aqueous electrolyte when using a negative electrode active material to which carbon nanofibers are attached, to reduce the surface tension of the non-aqueous electrolyte.

A non-aqueous electrolyte secondary battery of the present invention comprises a positive electrode, a negative electrode, a separator, and a non-aqueous electrolyte. The negative electrode includes an active material and carbon nanofibers, and one end of the carbon nanofiber is attached to the active material. The non-aqueous electrolyte includes a non-aqueous solvent and a solute dissolved therein. The non-aqueous solvent includes a first solvent and a second solvent: the first solvent is a fluorine-containing compound and the second solvent is a solvent other than the fluorine-containing compound.

The amount of the carbon nanofibers is preferably 10 to 50 parts by weight per 100 parts by weight of the negative electrode active material.

In one embodiment of the present invention, the fluorine-containing compound is preferably a compound represented by the following general formula (1): 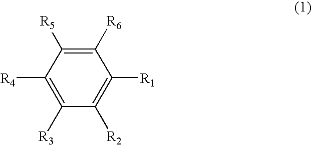
where R₁, R₂, R₃, R₄, R₅, and R₆ represent a fluorine atom or a hydrogen atom independently, and at least one of R₁, R₂, R₃, R₄, R₅, and R₆ is a fluorine atom. The fluorine-containing compound represented by the formula (1) is preferably monofluorobenzene.

The amount of the fluorine-containing compound represented by the formula (1) is preferably 5 to 30 parts by weight per 100 parts by weight of the second non-aqueous solvent.

In another embodiment of the present invention, the fluorine-containing compound is preferably a compound represented by the following general formula (2): 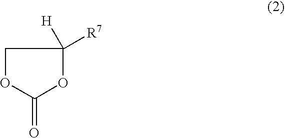
where R₇ is a fluorine atom or a methyl group in which at least one hydrogen atom is replaced with a fluorine atom. The fluorine-containing compound represented by the formula (2) preferably makes up 5 to 30% of the total volume of the non-aqueous solvent.

The negative electrode active material preferably includes a compound represented by SiOₓ (0.05≦x≦1.95), and SiOₓ preferably makes up at least 50 wt % of the negative electrode active material.

While the novel features of the invention are set forth particularly in the appended claims, the invention, both as to organization and content, will be better understood and appreciated, along with other objects and features thereof, from the following detailed description taken in conjunction with the drawings.

### DETAILED DESCRIPTION OF THE INVENTION

A non-aqueous electrolyte secondary battery of the present invention includes a positive electrode, a negative electrode, and a non-aqueous electrolyte. The negative electrode includes an active material and carbon nanofibers, and one end of the carbon nanofiber is attached to the active material. The non-aqueous electrolyte includes a non-aqueous solvent and a solute dissolved therein. The non-aqueous solvent includes a first solvent and a second solvent. The first solvent is a fluorine-containing compound, and the second solvent is a solvent other than the fluorine-containing compound.

By including the fluorine-containing compound in the non-aqueous electrolyte, the surface tension of the non-aqueous electrolyte declines. Thus, the decline in negative electrode active material wettability by the non-aqueous electrolyte because of carbon nanofibers can be prevented. Also, by initial charging, a coating derived from the above fluorine-containing compound is formed on the negative electrode active material surface, thereby curbing the decomposition of the non-aqueous electrolyte. Further, since carbon nanofibers are attached to the negative electrode active material surface, the electron conductivity in the negative electrode can be improved as well. Thus, cycle performance and battery capacity can be improved.

Additionally, the non-aqueous electrolyte including the fluorine-containing compound has a low surface tension. The low surface tension enables the injection of a non-aqueous electrolyte in a short period of time in a battery using a negative electrode active material to which carbon nanofibers are attached. Battery productivity is thus improved.

Therefore, the present invention achieves providing a high capacity non-aqueous electrolyte secondary battery with excellent cycle performance and productivity.

The amount of the carbon nanofibers to be attached to the negative electrode active material is preferably 10 to 50 parts by weight, and further preferably 20 to 30 parts by weight per 100 parts by weight of the negative electrode active material. When the amount of the carbon nanofibers is below 10 parts by weight per 100 parts by weight of the negative electrode active material, since the electron conductivity of the negative electrode cannot be improved sufficiently, effects on improving cycle performance cannot be obtained sufficiently. When the amount of the carbon nanofibers exceeds 50 parts by weight per 100 parts by weight of the negative electrode active material, since the amount of the carbon nanofibers in the negative electrode is large, even with the addition of the fluorine-containing compound to the non-aqueous electrolyte, the non-aqueous electrolyte cannot be injected appropriately.

For the fluorine-containing compound to be added to the non-aqueous electrolyte, for example, a fluorine-containing aromatic compound represented by the following general formula (1) may be used: 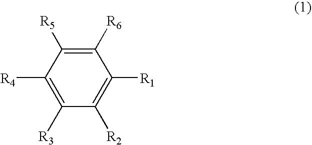
where R₁, R₂, R₃, R₄, R₅, and R₆ represent a fluorine atom or a hydrogen atom independently, and at least one of R₁, R₂, R₃, R₄, R₅, and R₆ is a fluorine atom.

The fluorine-containing aromatic compound represented by the formula (1) has a low surface tension and a low viscosity. By adding such a fluorine-containing aromatic compound to the non-aqueous electrolyte, the surface tension and the viscosity of the non-aqueous electrolyte can be reduced. Therefore, the injection of the non-aqueous electrolyte can be drastically improved. Also, the above fluorine-containing aromatic compound forms a firm coating on the negative electrode surface by initial charging. This coating is formed by adsorption of the fluorine-containing aromatic compound to the negative electrode surface, or by reaction of the negative electrode active material and the fluorine-containing aromatic compound. With the formation of such a coating on the negative electrode surface, the decomposition of the non-aqueous electrolyte due to the direct contact between the negative electrode active material and the non-aqueous electrolyte can be curbed. Thus, cycle performance can be improved.

For the fluorine-containing aromatic compound represented by the above formula (1), for example, monofluorobenzene, difluorobenzene, trifluorobenzene, tetrafluorobenzene, pentafluorobenzene, and hexafluorobenzene may be mentioned.

The number of fluorine atom included in the fluorine-containing aromatic compound represented by the formula (1) is preferably 1 or more and 6 or less. Among these examples, monofluorobenzene is particularly preferable. Since one hydrogen atom included in benzene is simply replaced with a fluorine atom, monofluorobenzene does not adsorb on the negative electrode active material surface excessively, and does not obstruct charge and discharge reaction. Therefore, by including monofluorobenzene in the non-aqueous electrolyte, non-aqueous electrolyte permeability to the electrode can be improved without affecting charge and discharge reaction.

The amount of the fluorine-containing aromatic compound represented by the formula (1) is preferably 5 to 30 parts by weight, and further preferably 10 to 20 parts by weight per 100 parts by weight of the second solvent. In the present invention, since the carbon nanofibers are attached to the negative electrode active material, wettability by the non-aqueous electrolyte is very low. Therefore, when the amount of the fluorine-containing aromatic compound of the formula (1) is below 5 parts by weight per 100 parts by weight of the second solvent, negative electrode active material wettability by the non-aqueous electrolyte becomes insufficient, declining cycle performance and productivity. When the amount of the fluorine-containing aromatic compound of the formula (1) exceeds 30 parts by weight per 100 parts by weight of the second solvent, the coating to be formed on the negative electrode surface becomes too thick and obstructs charge and discharge reaction. Thus, battery capacity and rate performance are declined.

Also, the fluorine-containing compound included in the non-aqueous electrolyte may be a fluorine-containing compound represented by the following general formula (2): 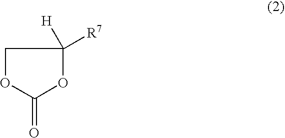
where R₇ is a fluorine atom or a methyl group in which at least one hydrogen atom is replaced with a fluorine atom. By including the fluorine-containing cyclic carbonic acid ester represented by the formula (2) in the non-aqueous electrolyte, with charging and discharging, a coating with excellent lithium ion conductivity derived from the fluorine-containing compound of the formula (2) is formed on the active material surface and the carbon nanofiber surface. By forming such a coating, non-aqueous electrolyte decomposition reaction while charge and discharge reaction can be curbed. Thus, cycle performance can be improved.

For the fluorine-containing compound represented by the formula (2), for example, 4-fluoro-1,3-dioxolan-2-one, and 4-trifluoromethyl-1,3-dioxolan-2-one may be mentioned.

The amount of the fluorine-containing compound of the formula (2) is preferably 5 to 30 vol %, and further preferably 10 to 20 vol % of a total volume of the non-aqueous solvent. When the amount of the fluorine-containing compound of the formula (2) is below 5 vol % of the non-aqueous solvent, the above affects cannot be obtained sufficiently. When the amount of the fluorine-containing compound of the formula (2) exceeds 30 vol % of the non-aqueous solvent, the coating to be formed on the active material and carbon nanofiber surface becomes thick, which may decline rate performance.

For the negative electrode active material, for example, the following may be used: natural graphite; artificial graphite; a silicon composite material such as silicide; a lithium alloy including at least one element selected from the group consisting of tin, aluminum, zinc, and magnesium; and various alloy composition materials.

Among the above, the negative electrode active material preferably includes a substance that is alloyable with lithium. The substance alloyable with lithium achieves providing a higher capacity, a higher energy density non-aqueous electrolyte secondary battery, compared with carbon materials generally used for the negative electrode active material currently.

For the substance alloyable with lithium, for example, Si; Sn; Ge; and an oxide and an alloy thereof may be mentioned.

The negative electrode active material may include SiOₓ (0.5≦x≦1.95). SiOₓ preferably takes up at least 50 wt % of the negative electrode active material, when the negative electrode active material includes SiOₓ.

SiOₓ can adsorb a large amount of Li per unit volume, but its electron conductivity is low. Therefore, when SiOₓ is used as the negative electrode active material, by attaching carbon nanofibers to SiOₓ, the electron conductivity of SiOₓ can be improved. Thus, a non-aqueous electrolyte secondary battery with a high energy density can be obtained.

Further, in SiOₓ, the potential that causes charge reaction is higher than that of graphite materials such as carbon nanofibers. Thus, in SiOₓ, charging reaction starts earlier than carbon nanofibers, forming the coating derived from the above fluorine-containing compound on the SiOₓ surface with priority.

By merely mixing SiOₓ and carbon nanofibers, with its high conductivity and high specific surface area, a coating is formed on carbon nanofibers with priority, and a coating is hardly formed on the SiOₓ surface, since the interface resistance between SiOₓ and carbon nanofibers is high. Thus, it is important to attach one end of the carbon nanofiber to SiOₓ to reduce the interface resistance.

As described above, with the formation by priority of a coating derived from the above fluorine-containing compound on the surface of SiOₓ having a large capacity, gas generation due to the decomposition of the non-aqueous electrolyte at the SiOₓ surface can be curbed. Thus, cycle performance can be further improved.

When the negative electrode active material includes SiOₓ, the negative electrode active material may include, other than SiOₓ, known negative electrode active material in the art, for example, the above-mentioned substance alloyable with lithium.

The negative electrode may be formed only of a negative electrode active material layer, or may be formed of a negative electrode current collector and a negative electrode active material layer carried thereon. The negative electrode active material layer may be formed of a negative electrode active material carrying carbon nanofibers, and may include arbitrary components such as a binder, other than the negative electrode active material. Binders to be used in the negative electrode include, for example, various resin materials such as modified and unmodified polyvinylidene fluorides, and modified and unmodified styrene-butadiene copolymers. For enhancing safety in the case of overcharge, when modified or unmodified styrene-butadiene copolymer is used as a binder, the binder is preferably used with a cellulose thickener such as carboxymethyl cellulose.

Other elements in the non-aqueous electrolyte secondary battery of the present invention are described next.

The positive electrode may be formed only of a positive electrode active material layer, and may be formed of a positive electrode current collector and a positive electrode active material layer carried thereon. The positive electrode active material layer may be formed only of a positive electrode active material, and may include arbitrary components such as a conductive material and a binder, other than the positive electrode active material.

For the positive electrode active material, composite oxides such as lithium cobaltate and modified lithium cobaltates (for example, a eutectic including aluminum and magnesium), lithium nickelate and modified lithium nickelates (for example, lithium nickelate with its nickel partially replaced with cobalt), and lithium manganate and unmodified lithium manganates may be mentioned. These may be used singly, or may be used in combination of two or more.

For the conductive material used in the positive electrode, carbon black such as acetylene black, and various graphite may be used. These may be used singly, or may be used in combination of two or more.

For the binder used in the positive electrode, known materials in the art may be used. Among them, a mixture of a fluorocarbon resin or a cellulose ether compound and a polymer material with an acrylate unit is preferably used as the binder. Examples of the fluorocarbon resin include polyvinylidene fluoride and polytetrafluoroethylene. Examples of the cellulose ether compound include a sodium salt and an ammonium salt of carboxymethyl cellulose. For the polymer material with an acrylate unit, a copolymer including a 2-ethylhexyl acrylate unit, an acrylic acid unit, and an acrylonitrile unit may be mentioned.

The non-aqueous solvent forming the non-aqueous electrolyte includes a second solvent as the main solvent. The second solvent preferably includes, as a main component, a cyclic carbonate and/or a linear carbonate. The cyclic carbonate is preferably at least one selected from the group consisting of ethylene carbonate, propylene carbonate, and butylene carbonate. The linear carbonate is preferably at least one selected from the group consisting of dimethyl carbonate, diethyl carbonate, and ethylmethyl carbonate.

For the solute included in the non-aqueous electrolyte, for example, lithium salt with strong electron attraction may be used. For such a lithium salt, for example, LiPF₆, LiBF₄, LiClO₄, LiAsF₆, LiCF₃SO₃, LiN(SO₂CF₃)₂, LiN(SO₂C₂F₅)₂, and LiC(SO₂CF₃)₃ may be mentioned. These may be used singly, or may be used in combination of two or more.

The concentration of the solute in the non-aqueous electrolyte is preferably 0.5 to 1.5 mol/L.

For forming an excellent coating on the positive electrode and/or on the negative electrode, and for securing stability under overcharged state, modified and unmodified vinylene carbonate, and modified and unmodified cyclohexyl benzene may be added as an additive to the non-aqueous electrolyte. In such a case, a coating in which the above fluorine-containing compound and the additive are mixed is formed.

The amount of the additive is preferably 1 to 10 wt % of the non-aqueous electrolyte.

For the separator, for example, a microporous film comprising a predetermined polymer material may be used. For the polymer material, for example, polyethylene, polypropylene, polyvinylidene fluoride, polyvinylidene chloride, polyacrylonitrile, polyacrylamide, polytetrafluoroethylene, polysulfone, polyethersulfone, polycarbonate, polyamide, polyimide, polyether (polyethylene oxide and polypropylene oxide), cellulose (carboxymethyl cellulose and hydroxypropyl cellulose), poly(metha)acrylic acid, and poly(metha)acrylic acid ester may be mentioned. Among these, a microporous film comprising polyethylene, polypropylene, and polyvinylidene fluoride is preferable. Also, a multi-layered film in which two or more of the microporous film comprising the material are stacked may be used as a separator. The thickness of the separator is preferably 15 to 25 μm.

For the battery case, a case comprising a steel plate with its inner face plated with nickel, and a case comprising an aluminum alloy may be used. For the battery form, cylindrical and prismatic form may be mentioned, but not limited thereto.

The present invention is described based on Examples in the following, but the present invention is not limited to these Examples.

### EXAMPLES

### Example 1

(Preparation of Non-Aqueous Electrolyte)

To a solvent mixture (second solvent) including ethylene carbonate (EC) and ethyl methyl carbonate (EMC) in a volume ratio of 30:70, LiPF₆ was dissolved in a concentration of 1.0 mol/L. To the solution, 15 parts by weight of monofluorobenzene (FB) per 100 parts by weight of the second solvent was added to prepare a non-aqueous electrolyte.

(Positive Electrode Preparation) The following were mixed: 85 parts by weight of the positive electrode active material (LiNi_{0.8}Co_{0.2}O₂) powder (average particle size: 5 μm), 10 parts by weight of acetylene black as a conductive agent, and 5 parts by weight of polyvinylidene fluoride as a binder. The obtained mixture was dispersed in dehydrated N-methyl-2-pyrrolidone, to prepare a slurry of a positive electrode material mixture. The obtained positive electrode material mixture was applied on both sides of an aluminum foil with a thickness of 20 μm, dried, and rolled, to obtain a positive electrode plate.

(Negative Electrode Preparation) The following were mixed: 100 parts by weight of silicon monoxide powder (reagent manufactured by Wako Pure Chemical Industries, Ltd.) which was crushed in advance and classified to give a particle size of 10 μm or less; 1 part by weight of nickel(II) nitrate hexahydrate (reagent chemical manufactured by Kanto Chemical Co., Inc.); and a predetermined amount of ion-exchange water. The obtained mixture was stirred for an hour. Afterwards, the ion-exchange water was removed from the mixture by using an evaporating device for drying. SiO particles with nickel(II) nitrate carried on the surface thereof were thus obtained. As a result of analysis on the obtained SiO particles with a scanning electron microscope (SEM), it was confirmed that the nickel(II) nitrate was particles with a particle size of about 100 nm.

The obtained active material particles were placed in a ceramic reaction vessel, and the temperature of the particles was raised to 550° C. in a helium gas atmosphere. Afterwards, the atmosphere in the reaction vessel was replaced with a mixed gas of 50 vol % hydrogen gas and 50 vol % ethylene gas, and the temperature of the active material particles was kept to 550° C. for an hour. Carbon nanofibers (hereinafter shown as CNF) were thus grown on the surface of the SiO particles while the nickel(II) nitrate was being reduced.

Then, the mixed gas in the reaction vessel was replaced with a helium gas, and temperature of the SiO particles carrying CNF was cooled to ambient temperature. Afterwards, the obtained composite particles were allowed to stand in an argon gas atmosphere at 700° C. for an hour to heat-treat CNF.

As a result of the SEM analysis on the obtained particles, it was confirmed that carbon nanofibers were attached to the SiO particle surface, and that the carbon nanofibers had a fiber diameter of about 80 nm and a length of about 100 μm. The amount of CNF was 25 parts by weight per 100 parts by weight of silicon monoxide.

The following were sufficiently mixed to obtain a slurry of a negative electrode material mixture: 100 parts by weight of SiO particles to which carbon nanofibers were attached to the surface thereof; an emulsion solution of styrene-butadiene rubber as a binder; 3 parts by weight of carboxymethyl cellulose (Celogen 4H manufactured by DAI-ICHI KOGYO SEIYAKU CO., LTD.) as a thickener; and an appropriate amount of ion-exchange water. The emulsion solution of styrene-butadiene rubber was added so that the amount of the styrene-butadiene rubber in the obtained negative electrode material mixture becomes 10 parts by weight.

The obtained negative electrode material mixture was applied to both sides of a copper foil with a thickness of 15 μm, dried, and rolled, to obtain a negative electrode plate.

(Battery Assembly)

The positive electrode plate and the negative electrode plate obtained as in the above were cut to give a length required. Afterwards, to an exposed portion of a positive electrode current collector provided at an end portion of the positive electrode plate, an aluminum-made positive electrode lead was welded. Similarly, to an exposed portion of a negative electrode current collector provided at an end portion of the negative electrode plate, a nickel-made negative electrode lead was welded.

A separator was disposed between the positive electrode plate and the negative electrode plate, and the obtained stack was spirally wound around to obtain an electrode assembly. For the separator, a porous polyethylene film (Hipore™ manufactured by Asahi Kasei Corporation.) with a thickness of 20 μm was used.

Then, a polypropylene-made insulating plate was disposed on top and bottom of the thus made electrode assembly, and the electrode assembly was inserted into a nickel-plated, cylindrical iron battery case. The battery case had a diameter of 18 mm and a height of 56 mm. The positive electrode lead was connected to an aluminum sealing plate having a polypropylene-made gasket, and the negative electrode lead was connected to the inner bottom face of the battery case.

To the battery case storing the electrode assembly, 5 cm³ of the above non-aqueous electrolyte was injected. The battery case was decompressed, to immerse the electrode assembly with the non-aqueous electrolyte. At this time, the time it took for the electrode assembly to be permeated by the non-aqueous electrolyte was determined. The obtained results are shown as injection time in Table 1.

Then, using the aluminum sealing plate having the polypropylene gasket, the opening end of the battery case was crimped to the end of the sealing plate with the gasket interposed therebetween, to seal the battery case. A cylindrical battery 1 with a designed capacity of 2400 mAh was thus made.

### Example 2

A battery 2 was made in the same manner as Example 1, except that the amount of FB included in the non-aqueous electrolyte was set to 5 parts by weight per 100 parts by weight of the second solvent.

### Example 3

A battery 3 was made in the same manner as Example 1, except that the amount of FB included in the non-aqueous electrolyte was set to 30 parts by weight per 100 parts by weight of the second solvent.

### Example 4

A non-aqueous electrolyte including a compound of the above formula (2) in which R₇ is a fluorine atom (4-fluoro-1,3-dioxolan-2-one)(hereinafter shown as F-EC) was prepared as in below.

EC, F-EC, and EMC were mixed in a volume ratio of 15:15:70 to obtain a solvent mixture. To the obtained solvent mixture, LiPF₆ was dissolved in a concentration of 1.0 mol/L, to prepare a non-aqueous electrolyte including F-EC. The amount of F-EC was 15 vol % of the non-aqueous solvent in total.

A battery 4 was made in the same manner as Example 1 by using the obtained non-aqueous electrolyte.

### Example 5

A battery 5 was made in the same manner as Example 4, except that the mixing ratio of EC, F-EC, and EMC in the solvent mixture was set to 25:5:70 (volume ratio). The amount of F-EC was 5 vol % of the non-aqueous solvent in total.

### Example 6

A battery 6 was made in the same manner as Example 4, except that a solvent mixture of F-EC and EMC (volume ratio 30:70) was used instead of the solvent mixture of EC, F-EC, and EMC. The amount of F-EC was 30 vol % of the non-aqueous solvent in total.

### Example 7

A battery 7 was made in the same manner as Example 4, except that a compound of the formula (2) in which R₇ is CF₃ (4-trifluoromethyl-1,3-dioxolan-2-one)(hereinafter, shown as F-PC) was used instead of F-EC. The amount of F-PC was 15 vol % of the non-aqueous solvent in total.

### Example 8

A battery 8 was made in the same manner as Example 4, except that the mixing ratio of EC, F-PC, and EMC in the solvent mixture was set to 25:5:70 (volume ratio). The amount of F-PC was 5 vol % of the non-aqueous solvent in total.

### Example 9

A battery 9 was made in the same manner as Example 4, except that a solvent mixture of F-PC and EMC (volume ratio 30:70) was used instead of the solvent mixture of EC, F-EC, and EMC. The amount of F-PC was 30 vol % of the non-aqueous solvent in total.

### Examples 10 to 13

Upon growing CNF on the SiO particles, by setting the time for the battery to stand at 550° C. in the mixed gas of hydrogen gas and ethylene gas to 10 minutes, 20 minutes, 2 hours, and 3 hours, the amount of CNF was set to 5 parts by weight, 10 parts by weight, 50 parts by weight, and 70 parts by weight per 100 parts by weight of SiO. Except for the above, batteries 10 to 13 were made in the same manner as Example 1.

### Example 14

Si particles to which CNF was attached were obtained in the same manner as Example 1, except that silicon powder (reagent manufactured by Wako Pure Chemical Industries, Ltd.; average particle size 10 μm) was used instead of silicon monoxide. The particle size of nickel(II) nitrate carried on the Si particle surface, and the fiber diameter, the fiber length, and the amount of the CNF grown were almost the same as those of Example 1.

A battery 14 was made in the same manner as Example 1, using the above Si particles to which CNF was attached.

### Example 15

SnO₂ particles to which CNF was attached were obtained in the same manner as Example 1, except that tin(IV) oxide powder (reagent chemical manufactured by Kanto Chemical Co., Inc.; average particle size 15 μm) was used instead of silicon monoxide. The particle size of the nickel(II) nitrate carried on the SnO₂ particle surface, and the fiber diameter, the fiber length, and the amount of the CNF grown was almost the same as those in Example 1.

A battery 15 was made in the same manner as Example 1 by using the above SnO₂ particles to which CNF was attached.

### Example 16

Ti—Si particles to which CNF was attached were obtained in the same manner as Example 1, except that a Ti—Si alloy made as in below was used instead of silicon monoxide. The particle size of the nickel(II) nitrate carried on the Ti—Si alloy particle surface, and the fiber diameter, the fiber length, and the amount of the CNF grown was almost the same as those in Example 1.

The Ti—Si alloy was made as in below.

50 parts by weight of titanium powder (reagent manufactured by KOJUNDO CHEMICAL LABORATORY CO., LTD., particle size 150 μm or less) and 100 parts by weight of silicon powder (reagent manufactured by Wako Pure Chemical Industries, Ltd.; average particle size 10 μm) were mixed. 3.5 kg of the obtained mixture was introduced into a vessel provided at a vibration mill device, along with stainless steel-made balls with a diameter of 2 cm. The stainless steel-made balls were set to 70 vol % of the vessel. These were subjected to a mechanical alloying process for 80 hours in an argon gas atmosphere to obtain a Ti—Si alloy.

The obtained Ti—Si alloy was subjected to an X-ray diffraction analysis (XRD) and observed with a transmission electron microscope (TEM). As a result, it was confirmed that in the obtained Ti—Si alloy, an amorphous phase, a Si phase of microcrystal with a crystallite size of about 10 nm to 20 nm, and a TiSi₂ phase of microcrystal with a crystallite size of about 10 nm to 20 nm existed. Assuming the Ti—Si alloy is made up only of Si and TiSi₂, the ratio of Si to TiSi₂ was about 30:70 (weight ratio).

A battery 16 was made in the same manner as Example 1, by using the above Ti—Si alloy particles to which CNF was attached.

### Example 17

Graphite particles with CNF attached were obtained in the same manner as Example 1, except that artificial graphite (SLP 30 manufactured by TIMCAL Graphite and Carbon; average particle size 16 μm) was used instead of silicon monoxide. The particle size of nickel(II) nitrate carried on the graphite particle surface, and the fiber diameter, the fiber length, and the amount of the CNF grown were almost the same as those in Example 1.

A battery 17 was made in the same manner as Example 1 by using the graphite particles to which the above CNF was attached.

### Example 18

A battery 18 was made in the same manner as Example 1, except that the amount of FB included in the non-aqueous electrolyte was set to 3 parts by weight per 100 parts by weight of the second solvent.

### Example 19

A battery 19 was made in the same manner as Example 1, except that the amount of FB included in the non-aqueous electrolyte was set to 40 parts by weight per 100 parts by weight of the second solvent.

### Example 20

A battery 20 was made in the same manner as Example 4, except that the mixing ratio of EC, F-EC, and EMC included in the solvent mixture was set to 27:3:70 (volume ratio). The amount of F-EC was 3 vol % of the non-aqueous solvent in total.

### Example 21

A battery 21 was made in the same manner as Example 4, except that a solvent mixture of F-EC and EMC (volume ratio 40:60) was used instead of the solvent mixture of EC, F-EC, and EMC. The amount of F-EC was 40 vol % of the non-aqueous solvent in total.

### Example 22

A battery 22 was made in the same manner as Example 7, except that the mixing ratio of EC, F-PC, and EMC included in the solvent mixture was set to 27:3:70 (volume ratio). The amount of F-PC was 3 vol % of the non-aqueous solvent in total.

### Example 23

A battery 23 was made in the same manner as Example 7, except that a solvent mixture of F-PC and EMC (volume ratio 40:60) was used instead of the solvent mixture of EC, F-PC, and EMC. The amount of F-PC was 40 vol % of the non-aqueous solvent in total.

### Comparative Example

A comparative battery was made in the same manner as Example 4, except that a solvent mixture of EC and EMC (volume ratio 30:70) was used instead of the solvent mixture of EC, F-EC, and EMC.

The batteries of the above Examples 1 to 23 and Comparative Example were evaluated as in below.

[Evaluation]

(Capacity Retention Rate)

A set of preliminary charge and discharge as in below was repeated twice. Each battery was charged at a constant current of 1680 mA until the battery voltage reached 4.1 V, and the charged battery was discharged at a constant current of 1680 mA until the battery voltage dropped to 2.5 V. Each battery was then allowed to stand at 20° C. for 7 days.

Afterwards, the battery was charged at a constant current of 1680 mA until the battery voltage reached 4.2 V, and charged at a constant voltage of 4.2 V until the current value reached 120 mA. The charged battery was discharged at a constant current of 2400 mA until the battery voltage dropped to 2.5 V. Such a cycle of charge and discharge was repeated 100 times.

The ratio of the discharge capacity at the 100th cycle relative to the discharge capacity at the 1st cycle was regarded as a capacity retention rate. The results are shown in Table 1. In Table 1, the capacity retention rate is shown in percentages.

(Rate Characteristics)

A set of preliminary charge and discharge as in below was repeated twice. Each battery was charged at a constant current of 1680 mA until the battery voltage reached 4.1 V, and the charged battery was discharged at a constant current of 1680 mA until the battery voltage dropped to 2.5 V. Each battery was then stored at 20° C. for 7 days.

Afterwards, the battery was charged at a constant current of 1680 mA until the battery voltage reached 4.2 V, and charged at a constant voltage of 4.2 V until the current value reached 120 mA. The charged battery was subjected to 0.2 C discharge and 2 C discharge as in below, and the discharge capacity at 0.2 C and the discharge capacity at 2 C were obtained. In 0.2 C discharge, the charged battery was discharged at a constant current of 480 mA, until the battery voltage dropped to 2.5 V. In 2 C discharge, the charged battery was discharged at a constant current of 4800 mA, until the battery voltage dropped to 2.5 V.

The ratio of the discharge capacity at 2 C relative to the discharge capacity at 0.2 C, i.e., discharge capacity at 2 C/discharge capacity at 0.2 C, was determined in percentage. The results are shown in Table 1 as rate performance.

Table 1 shows the kind of the negative electrode active material, the amount of CNF (parts by weight) per 100 parts by weight of the negative electrode material, and the kind and the amount of the fluorine-containing compound. When the fluorine-containing compound is FB, Table 1 shows the amount of FB (parts by weight) per 100 parts by weight of the second solvent. When the fluorine-containing compound is F-EC or F-PC, Table 1 shows the amount of F-EC or F-PC (vol %) in the total volume of the non-aqueous solvent.

TABLE 1

| | | Amount | | | | | |
|---|---|---|---|---|---|---|---|
| | Negative | of CNF | | Amount of | | | |
| | Electrode | (parts | Fluorine- | fluorine- | Capacity | Injection | Rate |
| | Active | by | containing | containing | Retention | Time | performance |
| | Material | weight) | compound | compound | Rate(%) | (min.) | (%) |
| Ex. 1 | SiO | 25 | FB | 15 parts | 85 | 6 | 78 |
| | | | | by weight | | | |
| Ex. 2 | | | | 5 parts | 74 | 14 | 81 |
| | | | | by weight | | | |
| Ex. 3 | | | | 30 parts | 87 | 4 | 74 |
| | | | | by weight | | | |
| Ex. 4 | | | F-EC | 15 vol % | 82 | 8 | 76 |
| Ex. 5 | | | | 5 vol % | 72 | 18 | 79 |
| Ex. 6 | | | | 30 vol % | 83 | 4 | 73 |
| Ex. 7 | | | F—PC | 15 vol % | 83 | 8 | 77 |
| Ex. 8 | | | | 5 vol % | 72 | 17 | 80 |
| Ex. 9 | | | | 30 vol % | 85 | 4 | 73 |
| Ex. 10 | | 5 | FB | 15 parts | 71 | 1 | 72 |
| Ex. 11 | | 10 | | by weight | 79 | 3 | 72 |
| Ex. 12 | | 50 | | | 87 | 20 | 80 |
| Ex. 13 | | 70 | | | 88 | 36 | 81 |
| Ex. 14 | Si | 25 | | | 76 | 5 | 71 |
| Ex. 15 | SnO₂ | 25 | | | 77 | 6 | 73 |
| Ex. 16 | Ti—Si | 25 | | | 81 | 4 | 75 |
| | alloy | | | | | | |
| Ex. 17 | Graphite | 25 | | | 90 | 8 | 85 |
| Ex. 18 | SiO | 25 | FB | 3 parts | 62 | 35 | 79 |
| | | | | by weight | | | |
| Ex. 19 | | | | 40 parts | 82 | 2 | 59 |
| | | | | by weight | | | |
| Ex. 20 | | | F-EC | 3 vol % | 56 | 43 | 75 |
| Ex. 21 | | | | 40 vol % | 76 | 3 | 53 |
| Ex. 22 | | | F—PC | 3 vol % | 57 | 41 | 79 |
| Ex. 23 | | | | 40 vol % | 78 | 2 | 58 |
| Comp. Ex. | | | — | — | 36 | 120 | 69 |

Comparison between the results of Examples 1 to 9 and 18 to 23, and the results of Comparative Example makes clear that by adding a fluorine-containing compound to the non-aqueous electrolyte, battery performance can be improved in addition to the fact that the injection time can be drastically shortened.

When the amount of the fluorine-containing compound is small, as in Examples 18, 20, and 22, the injection time

When the amount of the fluorine-containing compound is small, as in Examples 18, 20, and 22, the injection time became longer and cycle performance declined. This is probably because the small amount of the fluorine-containing compound caused the viscosity of the non-aqueous electrolyte to be higher.

When the amount of the fluorine-containing compound is large, as in Examples 19, 21, and 23, the injection time and cycle performance achieved excellent results. However, rate performance declined. This is probably because the coating derived from the fluorine-containing compound formed on the active material surface and the carbon nanofiber surface became excessively thick to cause a high interface resistance with the non-aqueous electrolyte.

Therefore, when a fluorine-containing aromatic compound represented by the formula (1) is used as the fluorine-containing compound, the amount of the fluorine-containing compound is preferably 5 to 30 parts by weight per 100 parts by weight of the second solvent. Additionally, when a compound represented by the formula (2) is used as the fluorine-containing compound, the amount of the fluorine-containing compound is preferably 5 to 30 vol % of the non-aqueous solvent in total.

The results of Examples 10 to 13 show that since the electron conductivity improved when the amount of CNF attached to the negative electrode active material was increased, cycle performance and rate performance both improved. However, the injection time became longer. This is probably because the large amount of CNF attached to the negative electrode active material made it difficult for the non-aqueous electrolyte to reach the negative electrode active material surface.

On the other hand, when the amount of CNF was small, the capacity retention rate slightly declined. This is probably because the conductive network in the negative electrode was not formed sufficiently due to the small amount of CNF.

Therefore, the amount of CNF is preferably 10 to 50 parts by weight per 100 parts by weight of the negative electrode active material.

The results of Examples 14 to 17 show that even the kind of the negative electrode active material was changed, cycle performance and rate performance were improved, and the injection time could be shortened.

A non-aqueous electrolyte secondary battery of the present invention has a high capacity and particularly excellent cycle performance. Therefore, the non-aqueous electrolyte secondary battery of the present invention is useful for a power source for, for example, small portable devices.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising a positive electrode, a negative electrode, a separator, and a non-aqueous electrolyte,
wherein said negative electrode includes an active material and a carbon nanofiber, an end of said carbon nanofiber being attached to said active material; and
said non-aqueous electrolyte includes a non-aqueous solvent and a solute dissolved in said non-aqueous solvent, said non-aqueous solvent including a first solvent and a second solvent, and said first solvent being a fluorine-containing compound and said second solvent being a solvent other than the fluorine-containing compound.

2. The non-aqueous electrolyte secondary battery in accordance with claim 1, wherein the amount of said carbon nanofiber is 10 to 50 parts by weight per 100 parts by weight of said active material.

3. The non-aqueous electrolyte secondary battery in accordance with claim 1, wherein said fluorine-containing compound is a compound represented by the general formula (1): 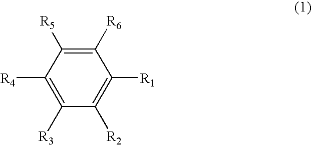
where R₁, R₂, R₃, R₄, R₅, and R₆ independently represent a fluorine atom or a hydrogen atom, and at least one of R₁, R₂, R₃, R₄, R₅, and R₆ is a fluorine atom.

4. The non-aqueous electrolyte secondary battery in accordance with claim 3, wherein said fluorine-containing compound represented by the formula (1) is monofluorobenzene.

5. The non-aqueous electrolyte secondary battery in accordance with claim 3, wherein the amount of said fluorine-containing compound represented by the formula (1) is 5 to 30 parts by weight per 100 parts by weight of said second non-aqueous solvent.

6. The non-aqueous electrolyte secondary battery in accordance with claim 1, wherein said fluorine-containing compound is a compound represented by the general formula (2): 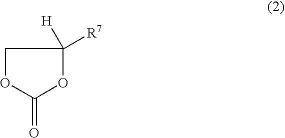
where R₇ is a fluorine atom or a methyl group in which at least one hydrogen atom is replaced with a fluorine atom.

7. The non-aqueous electrolyte secondary battery in accordance with claim 6, wherein the amount of said fluorine-containing compound represented by the formula (2) is 5 to 30% of a total volume of said non-aqueous solvent.

8. The non-aqueous electrolyte secondary battery in accordance with claim 1, wherein said negative electrode active material includes a compound represented by SiOₓ (0.05≦x≦1.95), and SiOₓ makes up at least 50 wt % of said negative electrode active material.
